(19) United States
(12) Patent Application Publication
(10) Pub. No.: US 2017/0091730 A1
(43) Pub. Date: Mar. 30, 2017

(54) METHOD AND SYSTEM FOR DYNAMIC PIN AUTHORISATION FOR ATM OR POS TRANSACTIONS

(71) Applicant: MasterCard International Incorporated, Purchase, NY (US)

(72) Inventors: Arunmurthy Gurunathan, Pune (IN); Ravi Pareek, Pune (IN)

(21) Appl. No.: 15/262,764

(22) Filed: Sep. 12, 2016

(30) Foreign Application Priority Data
Sep. 29, 2015 (SG) 10201508081T

(51) Int. Cl. G06Q 20/10; G06Q 20/20; G06Q 20/34; G06F 21/12

(52) U.S. Cl. CPC G06Q 20/1085; G06F 21/121; G06Q 20/206; G06Q 20/34

(57) ABSTRACT

A computer-implemented method is proposed for OTP authorisation for ATM or POS transactions. The method comprises: a) storing in a database a reference code for an OTP application installed on a user device and details for one or more of the user's payment cards in association with the reference code; b) receiving, along with payment card details, an OTP generated by the application and entered by the user into an ATM or POS terminal; c) validating the OTP; and d) on successful validation, authorising a payment transaction from the payment card.

### CROSS-REFERENCE TO RELATED APPLICATION

This application is a U.S. National Stage filing under 35 U.S.C. §119, based on and claiming benefit of and priority to SG Patent Application No. 10201508081T filed Sep. 29, 2015.

### FIELD OF THE INVENTION

The present invention relates to a method and system for dynamic PIN (personal identification number) authorisation for Automated Teller Machine (ATM) or Point of Sale (POS) transactions (i.e. Card present and Cardholder present scenarios).

### BACKGROUND

Currently static PINs are used at ATMs/POS devices to authenticate card payment transactions. However, this poses a security threat since the activity of entering the static pin could be monitored or traced and re-used fraudulently. Furthermore, issuer banks send static PINs to cardholders in a paper hard copy which is vulnerable to interception and also entails administration costs and has an environmental impact.

One time passwords OTPs (also known as dynamic PINs) are currently only used for card-not-present (CNP) online transactions, for example, during online banking.

It is therefore an aim of the present invention to provide a method and system for OTP authorisation for ATM or POS transactions that can ameliorate the problems associated with static PINs.

### SUMMARY OF THE INVENTION

In accordance with a first aspect of the invention there is provided a computer-implemented method for OTP authorisation for ATM or POS transactions comprising:
a) storing in a database a reference code for an OTP application installed on a user device and details for one or more of the user's payment cards in association with the reference code;
b) receiving, along with payment card details, an OTP generated by the application and entered by the user into an ATM or POS terminal;
c) validating the OTP; and
d) on successful validation, authorising a payment transaction from the payment card.

Thus, embodiments of present invention allow for the use of OTPs (e.g. dynamic PINs) instead of static PINs at ATM and POS terminals thereby negating the need for static PINs to be issued, maintained and kept secure. The use of OTPs is believed to be more secure than static PINs because they are generally only valid for a limited period of time (e.g. 3 minutes) or for a single transaction. Accordingly, even if an OTP is intercepted it will be of limited or no use to a potential fraudster.

Embodiments of the invention have many benefits for each of the parties involved in its implementation. For merchants and ATM operators, the system is highly secured and the risk of fraud at ATMs/POS terminals is minimised. As mentioned above, the use of an OTP means that even if it is monitored or hacked, it cannot be re-used as a different PIN will be required for the next use of the card. Cardholders will therefore enjoy an excellent customer experience and peace of mind that their PIN is not at risk of fraudulent use. Embodiments of the invention negate the need for cardholders to maintain multiple PINs for multiple cards and allow the use of OTPs for multiple cards through a single application. Furthermore, stolen, lost or sold user devices do not require card blocking since the application itself can be disabled. For payment network operators, acquirers and issuers the cost of encryption/decryption associated with maintaining static PINs could be reduced as the OTPs will entail a good level of security without being encrypted due to their one time use. Issuer banks would not need to print default PINs and courier them to customers leading to paper savings. They could also do away with Interactive Voice Recognition (IVR) options for forgotten PINs and PIN reissue. This will also eradicate the need for customers to memorise PINs.

Embodiments of the invention will be of use for Card Present and Card Holder Present transactions, which are typically performed at ATMs or POS terminals.

It should be noted that the OTP may comprise one or more of numbers, letters, symbols or other characters, and may be a mixture of e.g. ASCII or UTF-8 symbols.

In accordance with aspects of the invention, a plurality of payment cards (e.g. credit/debit/corporate/prepaid/loyalty) may be associated with the reference code so that an OTP can be generated for any one of the plurality of payment cards using a single application. Notably, a single applicant can provide OTPs for a number of different cards from a number of different issuers.

The user device may be a smartphone, tablet, PDA or laptop.

In embodiments of the invention, the application is configured to generate OTPs regardless of whether or not the user device is connected to a telecommunications network (i.e. the application may be operable with or without an internet connection and/or with or without presence of a mobile network).

In accordance with embodiments of the invention, the user must install the application on the user device. The act of installation will create a unique reference code for the application on the user device. The reference code will be communicated to the user by the user device.

The user will then associate with the reference code any payment cards they wish to use such that the details of the payment cards are stored in the database alongside the reference code. The user may associate a payment card with the reference code by making a request through a card issuer (e.g. an issuer bank). The issuer will send details of the payment card and reference code (as provided by the user) to the database for storing in association.

Once a payment card has been stored in the database against the application reference code it can be used with an OTP.

If more than one card is stored in association with a single application, the user may be required to select the card they wish to use. This may be achieved by any suitable way of identifying a particular one of multiple cards. For example, the user may provide nicknames for each of their cards or they may enter a portion of the card number as an identifier (e.g. the last 4 digits).

Once a card has been selected, the user may select to generate an OTP and the application will use an algorithm to generate the OTP on the user device (i.e. without requiring an internet or mobile network connection). The algorithm may use some or all of the digits of the payment card and/or the reference code and/or a time stamp to generate the OTP. For example, during the time of installation, the application may check a server time and calculate a difference of time in the time of the server and the time of the user device. The application may save this time difference in a local database associated with the application on the user device. Also, every time the user device goes online, the time difference could be synced with the server. The current timestamp of the server can then be calculated each time the application is run using the previously saved time difference. This will ensure that the timestamp on the user device is in sync with the server. The following is an indicative algorithm which could be employed or enhanced further during implementation where b is a unique 4 digit OTP:
a=(product of payment card number, reference code and current time stamp for the server in format DD:MM:YYYY HH:MM); and
b=last four digits (ignoring the decimal point) of a;
and b is returned as the OTP.

The OTP may then be displayed on the user device so that the user can enter it into an ATM or POS terminal to authorise payment from the card. The card itself will also need to be scanned by the ATM or POS terminal in the usual manner. However, instead of then entering a static PIN (as per current systems), the user will enter the OTP. The ATM or POS terminal will send the card details and the OTP to the acquirer (i.e. merchant bank) in the same way as they do currently for a static PIN card transaction. The acquirer will then send the details onto a payment network that will communicate with the issuer bank for the user's payment card.

The issuer bank will then communicate with a security code administration system (which may be considered as a token provider) to validate the OTP. The security code administration system will have access to the database and will be able to validate the OTP. For example, if the application syncs with the security code administration system server time as described above, even without internet or mobile network access, the security code administration system can use the same algorithm to validate the OTP.

If the OTP is validated as correct, the security code administration system will send a message to the issuer bank to proceed with the transaction and any further validation will be completed as normal (i.e. checking the balance available etc.). The issuer bank will then communicate with the payment network to complete the transaction.

If the OTP is deemed to be incorrect, the security code administration system will communicate the same with the issuer bank and the transaction will be refused.

The application may comprise a security feature to prevent unauthorised access. The security feature may comprise one or more of a PIN, password or biometrics.

In the case of a stolen, lost or sold user device, the user may be able to de-link their cards from the application installed on the device. This may be achieved by the user contacting the issuer bank and requesting that the application be disabled. The issuer bank may then send a message to the security code administration system to update the database by de-linking the application in question from all of the user's cards. Notably, none of the user's cards need to be blocked (only the application itself). Also, when a card is lost or stolen, the user can call the issuer bank to block the card and also de-link the card from the application.

A user may install the application on a new/other user device such that they are provided with a new reference code. They can then request that the issuer bank links their cards to the new reference code by updating the database accordingly.

In embodiments of the invention, the OTP may only be valid for use for a predetermined period (e.g. up to 30 seconds, up to 1 minute, up to 3 minutes or up to 30 minutes).

In embodiments of the invention, a user may set up a fall-back static PIN in case, for example, their user device runs out of battery power when required to generate an OTP. As a further fall-back mechanism, the user could pre-register a secondary mobile phone number wherein the user may request an OTP by sending a message to the issuer bank in pre-defined format and/or by calling the issuer bank from the secondary number.

A server may be configured to carry out one, more than one or all of the methods steps (a) to (d).

In accordance with a second aspect of the invention there is provided a computer system for OTP authorisation for ATM or POS transactions comprising:
a) a database storing a reference code for an OTP application installed on a user device and details for one or more of the user's payment cards in association with the reference code; and
b) a verification engine configured to:
   i. receive, along with payment card details, an OTP generated by the application and entered by the user into an ATM or POS terminal;
   ii. validate the OTP; and
   iii. on successful validation, authorise a payment transaction from the payment card.

Embodiments of the invention may be implemented in the form of a centralised computer system (e.g. a server) which presents an interface to which system administrators may connect (e.g. over the internet).

The optional method features described above may be implemented using the computer system according to the second aspect of the invention.

In accordance with a third aspect of the invention there is provided a non-transitory computer-readable medium having stored thereon program instructions for causing at least one processor to perform the method according to the first aspect of the invention.

### BRIEF DESCRIPTION OF THE DRAWINGS

Embodiments of the invention will now be described, by way of example only, with reference to the following drawings, in which:

FIG. 1 is a flowchart of a method according to an embodiment of the present invention;

FIG. 2 is a block diagram of a computer system according to an embodiment of the present invention;

FIG. 3 is a flowchart of an application installation and card registration procedure in accordance with an embodiment of the present invention;

FIG. 4 is a flowchart of an application de-link procedure in accordance with an embodiment of the present invention.

FIG. 5 is a flowchart of a PIN generation and authorisation procedure in accordance with an embodiment of the present invention;

FIG. 6 is a block diagram illustrating a technical architecture of a server of FIG. 2; and

FIG. 7 is a block diagram illustrating a technical architecture of a user device which may be employed in the implementation of embodiments of the invention.

### DETAILED DESCRIPTION OF CERTAIN EMBODIMENTS

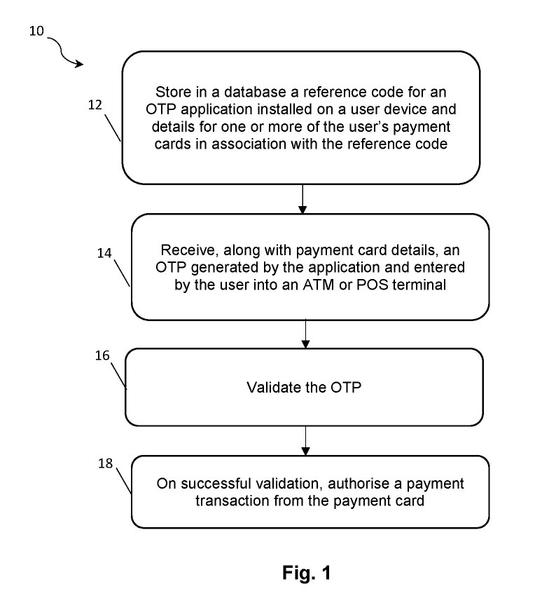

In accordance with an embodiment of the present invention there is provided a computer-implemented method 10 for OTP authorisation for ATM or POS transactions as illustrated in FIG. 1. In particular, the method comprises the following steps:

Step 12: storing in a database a reference code for an OTP application installed on a user device and details for one or more of the user's payment cards in association with the reference code;

Step 14: receiving, along with payment card details, an OTP generated by the application and entered by the user into an ATM or POS terminal;

Step 16: validating the OTP; and

Step 18: on successful validation, authorising a payment transaction from the payment card.

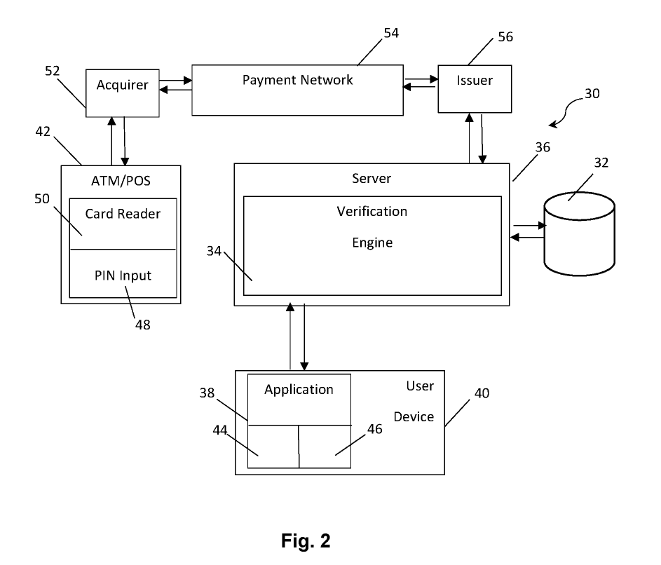

FIG. 2 shows a block diagram of a computer system 30 according to an embodiment of the present invention. The computer system 30 is configured for OTP authorisation for ATM or POS transactions in accordance with the method described above and comprises a database 32 and a verification engine 34 provided on a server 36.

The database 32 is arranged to store a reference code for an OTP application 38 installed on a user device 40 and details for one or more of the user's payment cards in association with the reference code, as will be explained in more detail below.

The verification engine 34 is configured to: a) receive, along with payment card details, an OTP generated by the application 38 and entered by the user into an ATM or POS terminal 42; b) validate the OTP; and c) on successful validation, authorise a payment transaction from the payment card.

The application comprises an algorithm 44 for generating an OTP and a display module 46 for presenting the OTP to the user so they can enter it into an input module 48 of the ATM/POS terminal 42. The terminal 42 also includes a card reader 50 for entering the user's card details.

Once entered, the card details and OTP are communicated to an acquirer (i.e. merchant/ATM bank) 52 where they are passed onto a payment network 54. The payment network 54 then communicates with an issuer bank 56 for the card concerned to approve the transaction.

Although not shown, the computer system 30 may further comprise a user interface UI for presenting verification information to a system operator, e.g. through a PC or mobile device. Furthermore, the computer system 30 may comprise a distributed system with one or more components (e.g. server or database) distributed over a network (i.e. the internet). In this particular embodiment, the user device 40 is a smartphone but in other embodiments it may be a tablet, PDA or laptop.

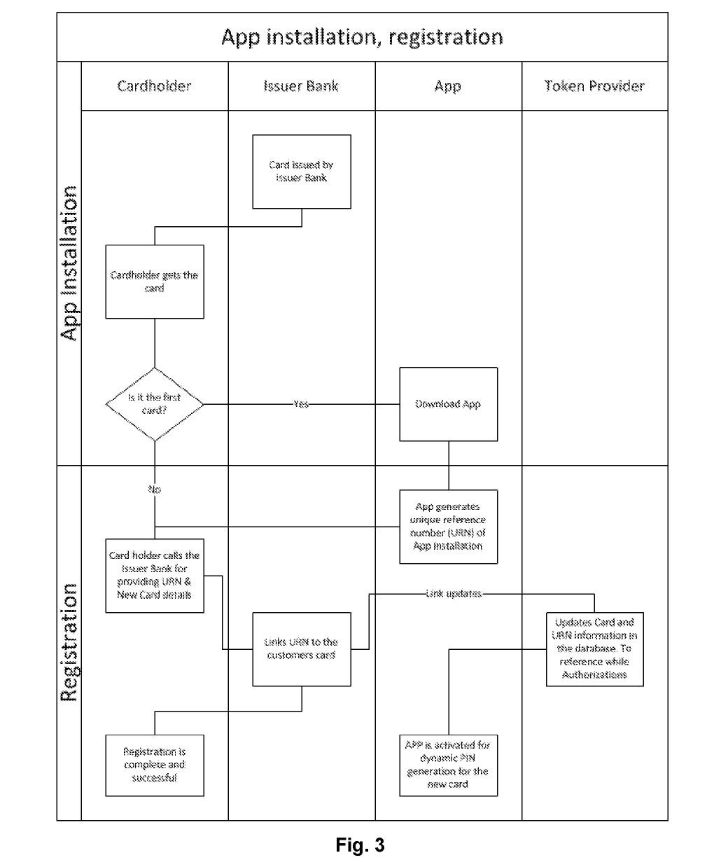

More detailed operation of the computer system 30 will be described below with reference to the flow diagrams of FIGS. 3, 4 and 5.

In particular, FIG. 3 is a flowchart showing a procedure for installation of the application 38 on the user device 40 and subsequent card registration. In this case, a card is issued to the cardholder by the issuer bank but no static PIN is issued. As it is the first card the user wishes to use without a static PIN they are required to download and install the OTP generation application on their user device (i.e. smartphone). This can be done by the user browsing in an application store for the application in question although other methods of installation are also envisaged.

The act of installing the application generates a unique reference code (in this case a unique reference number URN) denoting the particular application installed on the particular user device. The application then displays the URN on the smartphone so the user can make note of it. The user then contacts the issuer to link the payment card to the URN. The issuer then relays the URN and card details to the server 36 (also referred to as a token provider) so the server 36 can store the details in the database 32. The server 36 then communicates with the application (e.g. over the internet) to activate the application so it can be used to generate OTPs for the card concerned. The server 36 may also inform the issuer that the registration process is complete and they may pass this message onto the user (e.g. by means of an SMS, email or other notification).

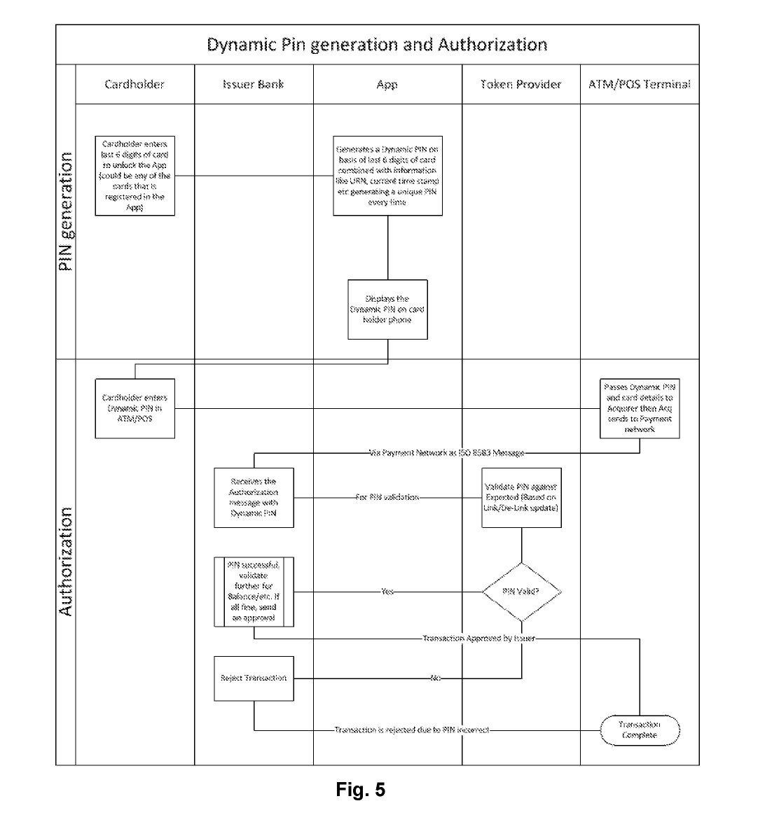

The user may follow a similar procedure to link further payment cards to the same application (i.e. without installing it again). In this way, a single application can be used to generate OTPs for all of a user's payment cards as will be explained in more detail with reference to FIG. 5 below.

In addition, the user may set up a security feature to prevent unauthorised use of the application and payment cards (e.g. if the user device is lost, stolen or sold). This may comprise the user setting up a PIN, password or biometric element to enable the application each time they wish to use it.

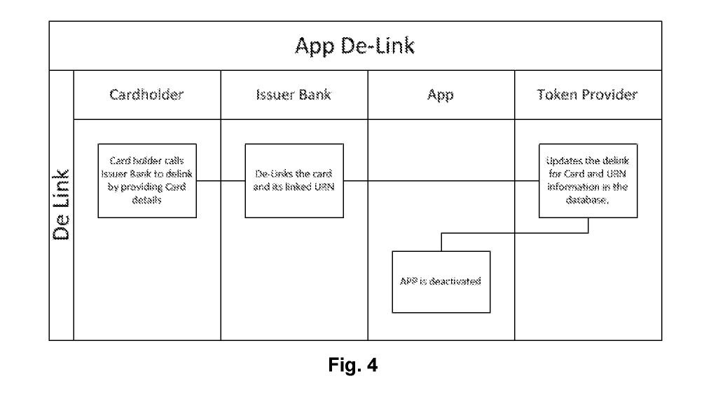

FIG. 4 is a flowchart of an application de-link procedure in accordance with an embodiment of the present invention. This procedure will be used if the user device is lost, stolen or sold in order to disable the application to prevent unauthorised use. This procedure requires the user to contact the issuer bank (e.g. by fax, phone, email or in person) to request that the application be disabled. The issuer bank will then send a message to the security code administration system/token provider/server to update the database by de-linking the application in question from all of the user's cards. Notably, none of the user's cards need to be blocked (only the application itself, which is locked by a message send from the server to the user device).

The user may then install the application on a new/other user device and follow the procedure of FIG. 3 to link their cards to the new URN.

FIG. 5 is a flowchart of an OTP generation and authorisation procedure in accordance with an embodiment of the present invention.

In this example, a card is selected for use and the user enters the last 4 digits of the card into a field displayed by the application on the smartphone in order to unlock the application. The application then uses an algorithm to generate an OTP using the last 6 digits of the card in combination with the URN and a current time stamp. More specifically, the following algorithm is employed to generate a unique 4 digit OTP, b:
a=(product of payment card number, reference code and current time stamp for the server in format DD:MM:YYYY HH:MM); and
b=last four digits (ignoring the decimal point) of a

Advantageously, the OTP generation is performed locally on the user device and does not require an internet or mobile network connection. The application causes the OTP to be displayed on a screen of the smartphone. The application may also display a countdown informing the user of how long they have left to use the OTP. In this embodiment, the OTP will be valid for up to 30 minutes but in other embodiments a different duration may be used.

In order to use the OTP, the user will provide their card so it can be scanned or the details manually entered into an ATM or POS terminal. They will then enter the OTP when prompted to do so by the ATM/POS terminal.

The ATM or POS terminal will send the card details and the OTP to the acquirer (i.e. merchant bank) in the same way as they do currently for a static PIN card transaction. The acquirer then sends the details onto the payment network that will communicate with the issuer bank for the user's payment card.

The issuer bank will then communicate with the security code administration system/token provider/server to validate the OTP. The server will have access to the database and will be able to verify the OTP using the same algorithm as described above for generating the OTP on the user device.

If the OTP is verified as correct, the server will send a message to the issuer bank to proceed with the transaction and any further verification will be completed as normal (i.e. checking the balance available etc.). The issuer bank will then communicate with the payment network to complete the transaction.

If the OTP is incorrect (or out of time), the server will communicate the same with the issuer bank and the transaction will be refused.

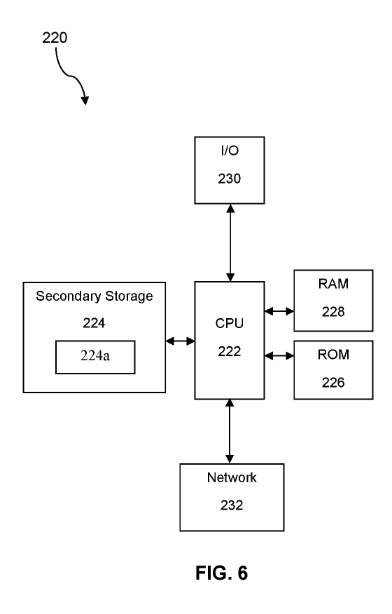

FIG. 6 is a block diagram illustrating a technical architecture of the server of FIG. 2 configured for performing the method 10 which is described above with reference to FIG. 1. Typically, the method 10 is implemented by a computer server having a data-processing unit. The block diagram as shown FIG. 6 illustrates a technical architecture 220 of a server which is suitable for implementing one or more embodiments herein.

The technical architecture 220 includes a processor 222 (which may be referred to as a central processor unit or CPU) that is in communication with memory devices including secondary storage 224 (such as disk drives), read only memory (ROM) 226, and random access memory (RAM) 228. The processor 222 may be implemented as one or more CPU chips. The technical architecture 220 may further comprise input/output (I/O) devices 230, and network connectivity devices 232.

The secondary storage 224 is typically comprised of one or more disk drives or tape drives and is used for non-volatile storage of data and as an over-flow data storage device if RAM 228 is not large enough to hold all working data. Secondary storage 224 may be used to store programs which are loaded into RAM 228 when such programs are selected for execution.

In this embodiment, the secondary storage 224 has a component 224a comprising non-transitory instructions operative by the processor 222 to perform various operations of the method of the present disclosure. The ROM 226 is used to store instructions and perhaps data which are read during program execution. The secondary storage 224, the RAM 228, and/or the ROM 226 may be referred to in some contexts as computer readable storage media and/or non-transitory computer readable media.

I/O devices 230 may include printers, video monitors, liquid crystal displays (LCDs), plasma displays, touch screen displays, keyboards, keypads, switches, dials, mice, track balls, voice recognizers, card readers, paper tape readers, or other well-known input devices.

The network connectivity devices 232 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 232 may enable the processor 222 to communicate with the Internet or one or more intranets. With such a network connection, it is contemplated that the processor 222 might receive information from the network, or might output information to the network in the course of performing the above-described method operations. Such information, which is often represented as a sequence of instructions to be executed using processor 222, may be received from and outputted to the network, for example, in the form of a computer data signal embodied in a carrier wave.

The processor 222 executes instructions, codes, computer programs, scripts which it accesses from hard disk, floppy disk, optical disk (these various disk based systems may all be considered secondary storage 224), flash drive, ROM 226, RAM 228, or the network connectivity devices 232. While only one processor 222 is shown, multiple processors may be present. Thus, while instructions may be discussed as executed by a processor, the instructions may be executed simultaneously, serially, or otherwise executed by one or multiple processors.

Although the technical architecture 220 is described with reference to a computer, it should be appreciated that the technical architecture may be formed by two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the technical architecture 220 to provide the functionality of a number of servers that is not directly bound to the number of computers in the technical architecture 220. In an embodiment, the functionality disclosed above may be provided by executing the application and/or applications in a cloud computing environment. Cloud computing may comprise providing computing services via a network connection using dynamically scalable computing resources. A cloud computing environment may be established by an enterprise and/or may be hired on an as-needed basis from a third party provider.

It should be understood that by programming and/or loading executable instructions onto the technical architecture 220, at least one of the CPU 222, the RAM 228, and the ROM 226 are changed, transforming the technical architecture 220 in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

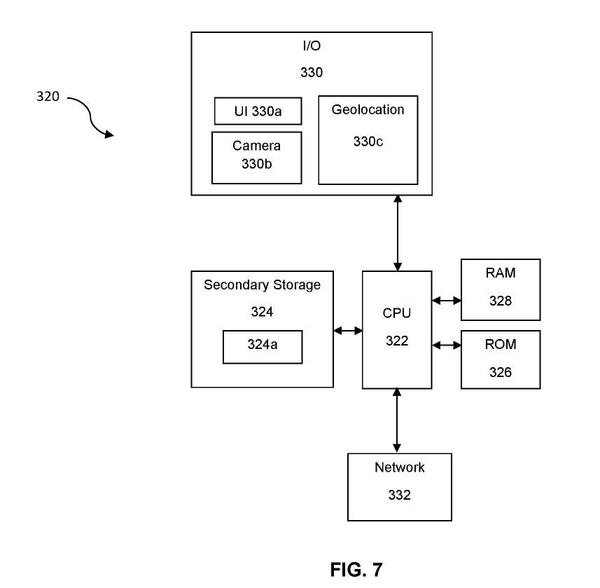

FIG. 7 is a block diagram illustrating a technical architecture of a user device which may be employed in the implementation of embodiments of the invention. It is envisaged that in embodiments, the user device will be a smartphone or tablet device. The block diagram as shown FIG. 4 illustrates a technical architecture 320 of a user device which is suitable for implementing one or more embodiments herein.

The technical architecture 320 includes a processor 322 (which may be referred to as a central processor unit or CPU) that is in communication with memory devices including secondary storage 324 (such as disk drives or memory cards), read only memory (ROM) 326, and random access memory (RAM) 328. The processor 322 may be implemented as one or more CPU chips. The technical architecture 320 further comprises input/output (I/O) devices 330, and network connectivity devices 332.

The I/O devices comprise a user interface (UI) 330a, a camera 330b and a geolocation module 330c. The UI 330a may comprise a touch screen, keyboard, keypad or other known input device. The camera 330b allows a user to capture images and save the captured images in electronic form. The geolocation module 330c is operable to determine the geolocation of the user device using signals from, for example global positioning system (GPS) satellites.

The secondary storage 324 is typically comprised of a memory card or other storage device and is used for non-volatile storage of data and as an over-flow data storage device if RAM 328 is not large enough to hold all working data. Secondary storage 324 may be used to store programs which are loaded into RAM 328 when such programs are selected for execution.

In this embodiment, the secondary storage 324 has a component 324a, comprising non-transitory instructions operative by the processor 322 to perform various operations of the method of the present disclosure. The ROM 326 is used to store instructions and perhaps data which are read during program execution. The secondary storage 324, the RAM 328, and/or the ROM 326 may be referred to in some contexts as computer readable storage media and/or non-transitory computer readable media.

The network connectivity devices 332 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 332 may enable the processor 322 to communicate with the Internet or one or more intranets. With such a network connection, it is contemplated that the processor 322 might receive information from the network, or might output information to the network in the course of performing the above-described method operations. Such information, which is often represented as a sequence of instructions to be executed using processor 322, may be received from and outputted to the network, for example, in the form of a computer data signal embodied in a carrier wave.

The processor 322 executes instructions, codes, computer programs, scripts which it accesses from hard disk, floppy disk, optical disk (these various disk based systems may all be considered secondary storage 324), flash drive, ROM 326, RAM 328, or the network connectivity devices 332. While only one processor 322 is shown, multiple processors may be present. Thus, while instructions may be discussed as executed by a processor, the instructions may be executed simultaneously, serially, or otherwise executed by one or multiple processors.

In embodiments of the invention, the server may generate HTML or XML code which a browser of the user device can use to generate a window presenting data on a screen of the user device.

As used in this document, the term “payment card” refers to any suitable cashless payment device, such as a credit card, a debit card, a prepaid card, a charge card, a membership card, a promotional card, a frequent flyer card, an identification card and/or a gift card. In addition, the term may encompass an online wallet system (such as the applicant's MasterPass™ system), in which, rather than a cardholder providing card data, he/she gives the merchant sufficient information to extract the card data from a database (e.g. operated by the card issuer, or by a card operator) where this data is stored.

Although only a single system and method according to embodiments of the present invention have been described in detail, many variations are possible in accordance with the appended claims.

1. A computer-implemented method for OTP authorisation for ATM or POS transactions comprising:
a) storing in a database a reference code for an OTP application installed on a user device and details for one or more of the user's payment cards in association with the reference code;
b) receiving, along with payment card details, an OTP generated by the application and entered by the user into an ATM or POS terminal;
c) validating the OTP; and
d) on successful validation, authorising a payment transaction from the payment card.

2. The method according to claim 1 wherein a plurality of payment cards are associated with the reference code so that an OTP can be generated for any one of the plurality of payment cards.

3. The method according to either preceding claim wherein the user device is a smartphone, tablet, PDA or laptop.

4. The method according to claim 1 wherein the application is configured to generate OTPs regardless of whether or not the user device is connected to a telecommunications network.

5. The method according to claim 1 wherein the installation of the application on the user device creates the reference code for the application on the user device and causes the user device to communicate the reference code to the user.

6. The method according to claim 1 wherein a payment card is associated with the reference code by a user-request through a card issuer.

7. The method according to claim 2, further comprising receiving a selection of one of the plurality of payment cards prior to generation of the OTP.

8. The method according to claim 1 wherein the application uses an algorithm to generate the OTP and the algorithm uses some or all of the digits of the payment card number and/or the reference code and/or a time stamp to generate the OTP.

9. The method according to claim 1 wherein the OTP is displayed on the user device.

10. The method according to claim 1 wherein the ATM or POS terminal transmits data indicative of the card details and the OTP to an acquirer system, wherein the acquirer system transmits data indicative of the details to a payment network, and wherein the payment network communicates with an issuer bank system to authorise the transaction.

11. The method according to claim 10 wherein the issuer bank communicates with a security code administration system to validate the OTP.

12. The method according to claim 11 wherein the security code administration system has access to the database in order to validate the OTP.

13. The method according to claim 11 wherein, if the OTP is validated as correct, the security code administration system sends a message to the issuer bank to proceed with the transaction and the issuer bank communicates with the payment network to complete the transaction.

14. The method according to claim 11 wherein, if the OTP is deemed to be incorrect, the security code administration system communicates that the OTP is incorrect to the issuer bank and the transaction is refused.

15. The method according to claim 1 wherein the application comprises a security feature to prevent unauthorised access.

16. The method according to claim 1, further comprising: receiving a user request to de-link one or more cards from the OTP application; and updating the database such that said one or more cards are no longer associated with the reference code.

17. The method according to claim 1 wherein the OTP is valid for use for a predetermined period.

18. The method according to claim 1, comprising storing in the database a fall-back static PIN associated with the reference code for use when the user is unable to generate an OTP.

19. A computer system for OTP authorisation for ATM or POS transactions comprising:
a) a database storing a reference code for an OTP application installed on a user device and details for one or more of the user's payment cards in association with the reference code; and
b) a verification engine configured to:
i. receive, along with payment card details, an OTP generated by the application and entered by the user into an ATM or POS terminal;
ii. validate the OTP; and
iii. on successful validation, authorise a payment transaction from the payment card.

20. A non-transitory computer-readable medium having executable instructions stored thereon, the medium comprising:
instructions to store, in a database, a reference code for a one time password (OTP) application installed on a user device and details for one or more of the user's payment cards in association with the reference code;
instructions for receiving, along with payment card details, an OTP generated by the application and entered by the user into an ATM or POS terminal;
instructions to validate the OTP; and
instructions to authorize a payment transaction from the payment card if the validation of the OTP is successful.
